(19) United States
(12) Patent Application Publication
(10) Pub. No.: US 2026/0245037 A1
(43) Pub. Date: Aug. 20, 2026

(54) INFORMATION PROCESSING DEVICE, INFORMATION PROCESSING METHOD, AND NON-TRANSITORY COMPUTER-READABLE MEDIUM

(71) Applicant: NEC Corporation, Tokyo (JP)

(72) Inventors: Yaeko YONEZAWA, Tokyo (JP); Yuji TAHARA, Tokyo (JP); Syunsuke YAMAMOTO, Tokyo (JP); Soma SHIRAISHI, Tokyo (JP); Naohiro HAYASHI, Tokyo (JP); Azusa NAGASAWA, Tokyo (JP); Ryosuke SAKAI, Tokyo (JP); Tomokazu KANEKO, Tokyo (JP); Takami SATO, Tokyo (JP)

(73) Assignee: NEC Corporation, Tokyo (JP)

(21) Appl. No.: 19/162,556

(22) PCT Filed: Mar. 23, 2023
(86) PCT No.: PCT/JP2023/011370

§ 371 Date: Sep. 5, 2025

(51) Int. Cl. G06Q 10/087; G06V 20/52

(52) U.S. Cl. CPC G06Q 10/08726; G06Q 10/08772; G06V 20/52

(57) ABSTRACT

Please delete the Abstract of the Disclosure, and replace it with the following:

Provided is an information processing device including an acquisition unit for acquiring an image in which a display space for merchandise is image-captured, an estimation unit for estimating a stocking rate of the merchandise in the image in a display space, on the basis of the image, and a control unit that performs notification of information relating to the merchandise in a case in which the stocking rate is no greater than a threshold value in accordance with whether the merchandise was stocked to the display space or rearranged to the front in work performed the previous time.

### TECHNICAL FIELD

The present disclosure relates to an information processing device, an information processing method, a non-transitory computer-readable medium storing a program, and a management system.

### BACKGROUND ART

PTL 1 discloses a technique that makes it possible to determine whether a product is displayed on a product shelf and makes it easy to manage a display status of the product.

### CITATION LIST

### Patent Literature

PTL 1: JP 2016-042307 A

### SUMMARY OF INVENTION

### Technical Problem

However, the technique described in PTL 1 has a problem that, for example, it may not be possible to appropriately promote the display of products.

In view of the above-described problems, an object of the present disclosure is to provide a technique capable of appropriately promoting display of a product.

### Solution to Problem

According to a first aspect of the present disclosure, there is provided an information processing device including an acquisition unit that acquires an image in which a display space of a product is photographed, an estimation unit that estimates a stocking rate with respect to a display space of the product captured in the image based on the image, and a control unit that performs notification of information regarding the product when the stocking rate is equal to or less than a threshold according to whether the product has been stocked or rearranged to a front in a previous work.

According to a second aspect according to the present disclosure, there is provided an information processing method including acquiring an image in which a display space of a product is photographed, estimating a stocking rate with respect to a display space of the product captured in the image based on the image, and performing notification of information regarding the product when the stocking rate is equal to or less than a threshold according to whether the product has been stocked or rearranged to a front in a previous work.

According to a third aspect according to the present disclosure, there is provided a non-transitory computer-readable medium storing a program for causing a computer to execute acquiring an image in which a display space of a product is photographed, estimating a stocking rate with respect to a display space of the product captured in the image based on the image, and performing notification of information regarding the product when the stocking rate is equal to or less than a threshold according to whether the product has been stocked or rearranged to a front in a previous work.

According to a fourth aspect of the present disclosure, there is provided a management system including an imaging device, an information processing device, and a terminal, in which the information processing device includes an acquisition unit that acquires an image in which a display space of a product is photographed by the imaging device, an estimation unit that estimates a stocking rate with respect to a display space of the product captured in the image based on the image, and a control unit that notifies the terminal of information regarding the product when the stocking rate is equal to or less than a threshold according to whether the product has been stocked or rearranged to a front in a previous work.

### Advantageous Effects of Invention

According to one aspect, it is possible to appropriately promote the display of a product.

### BRIEF DESCRIPTION OF DRAWINGS

FIG. 1 is a diagram illustrating an example of a configuration of an information processing device according to an example embodiment.

FIG. 2 is a diagram illustrating an example of a configuration of a management system according to an example embodiment.

FIG. 3 is a diagram illustrating a hardware configuration example of the information processing device according to the example embodiment.

FIG. 4 is a flowchart illustrating an example of processing of the information processing device according to the example embodiment.

FIG. 5 is a diagram illustrating an example of a display work DB (database) according to the example embodiment.

FIG. 6 is a diagram illustrating an example of a display screen according to the example embodiment.

### EXAMPLE EMBODIMENT

The principles of the present disclosure will be described with reference to several example embodiments. It is to be understood that the example embodiments have been described for purposes of illustration only and will aid those skilled in the art in understanding and carrying out the present disclosure without suggesting limitations on the scope of the present disclosure. The disclosure described in the present description is implemented in various methods other than those described below.

In the following description and claims, unless defined otherwise, all technical and scientific terms used in the present specification have the same meaning as commonly understood by those skilled in the art of the technical field to which the present disclosure belongs.

Hereinafter, example embodiments of the present disclosure will be described with reference to the drawings.

### First Example Embodiment

### Configuration

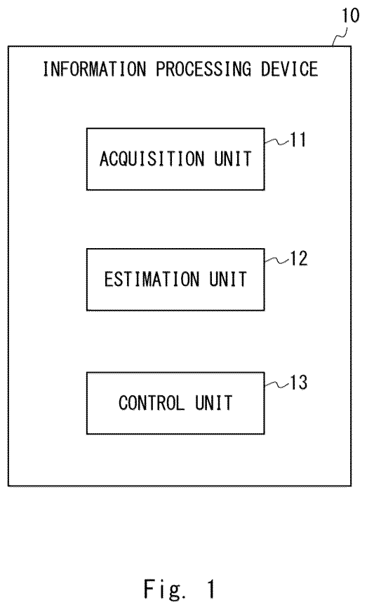

A configuration of an information processing device 10 according to an example embodiment will be described with reference to FIG. 1. FIG. 1 is a diagram illustrating an example of a configuration of the information processing device 10 according to the example embodiment. The information processing device 10 includes an acquisition unit 11, an estimation unit 12, and a control unit 13. These units may be implemented by cooperation of one or more programs installed in the information processing device 10 and hardware such as a processor 101 and a memory 102 of the information processing device 10.

The acquisition unit 11 acquires an image in which a product display space is photographed. Based on the image acquired by the acquisition unit 11, the estimation unit 12 estimates the stocking rate with respect to the display space of the product captured in the image. In a case where the stocking rate estimated by the estimation unit 12 is equal to or less than a threshold relevant to whether the product has been stocked or rearranged to the front in the previous work, the control unit 13 performs notification of information regarding the product.

### Second Example Embodiment

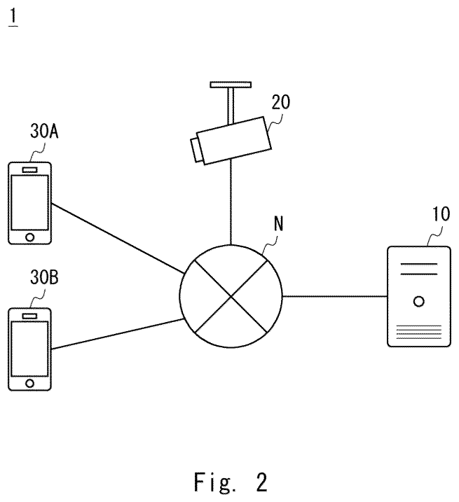

Next, a configuration of a management system 1 according to the example embodiment will be described with reference to FIG. 2.

### System Configuration

FIG. 2 is a diagram illustrating an example of a configuration of the management system 1 according to an example embodiment. In the example of FIG. 2, the management system 1 includes an information processing device 10 and an imaging device 20. The management system 1 includes a terminal 30A and a terminal 30B (hereinafter, in a case where there is no need to distinguish, the terminals are also simply referred to as “terminals 30”). The numbers of the information processing devices 10, the imaging devices 20, and the terminals 30 are not limited to the example of FIG. 2.

In the example of FIG. 2, the information processing device 10, the imaging device 20, and the terminal 30 are connected so as to be able to communicate via a network N. Examples of the network N include the Internet, a mobile communication system, a wireless local area network (LAN), short-range wireless communication such as Bluetooth Low Energy (BLE), a LAN, a bus, and the like. Examples of the mobile communication system include a fifth generation mobile communication system (5G), a fourth generation mobile communication system (4G), a third generation mobile communication system (3G), and the like.

The information processing device 10 may be, for example, a device such as a server, a cloud server, a personal computer, or a smartphone. The information processing device 10 transmits a notification related to the display of the product to the terminal 30 based on the image captured by the imaging device 20.

The imaging device 20 is, for example, an imaging device (camera) installed on a ceiling or the like of a store. For example, the imaging device 20 photographs a display space of each product.

The terminal 30 is, for example, a terminal such as a smartphone, a tablet, or a notebook personal computer. The terminal 30 may be carried by, for example, a salesclerk or the like, or may be installed in a space (backyard, backroom) or the like of the store where a user does not enter. The terminal 30 notifies the salesclerk or the like of the notification (information) received from the information processing device 10.

### Hardware Configuration

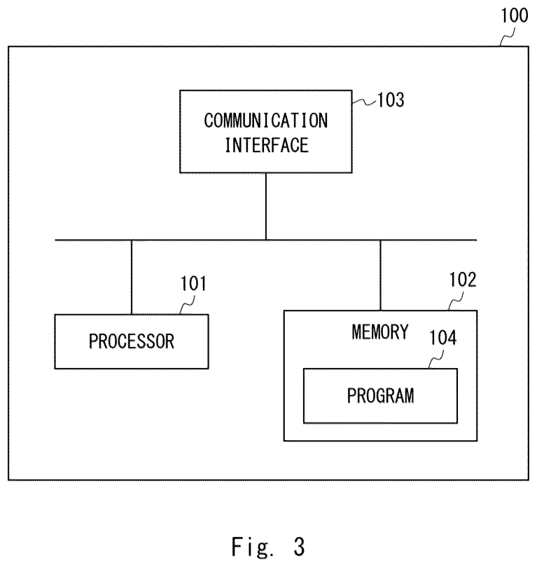

FIG. 3 is a diagram illustrating a hardware configuration example of the information processing device 10 according to the example embodiment. In the example of FIG. 3, the information processing device 10 (computer 100) includes a processor 101, a memory 102, and a communication interface 103. These units may be connected by a bus or the like. The memory 102 stores at least a part of a program 104. The communication interface 103 includes an interface necessary for communication with other network elements.

When the program 104 is executed by the cooperation of the processor 101, the memory 102, and the like, at least a part of processing according to the example embodiment of the present disclosure is performed by the computer 100. The memory 102 may be of any type suitable for a local technology network. The memory 102 may be a non-transitory computer-readable storage medium, as a non-limiting example. The memory 102 may also be implemented using any suitable data storage technique such as a semiconductor-based memory device, a magnetic memory device and system, an optical memory device and system, a fixed memory, or a removable memory. Although only one memory 102 is illustrated in the computer 100, there may be several physically different memory modules in the computer 100. The processor 101 may be of any type. The processor 101 may include one or more of a general purpose computer, a dedicated computer, a microprocessor, a digital signal processor (DSP), and a processor based on a multi-core processor architecture as a non-limiting example. The computer 100 may include a plurality of processors such as application specific integrated circuit chips that are temporally dependent on a clock that synchronizes the main processor.

The example embodiments of the present disclosure may be implemented in hardware or dedicated circuitry, software, logic, or any combination thereof. Some aspects may be implemented in hardware, while other aspects may be implemented in firmware or software that may be executed by a controller, a microprocessor or other computing devices.

The present disclosure also provides at least one computer program product tangibly stored on a non-transitory computer-readable storage medium. The computer program product includes computer-executable instructions, such as those included in a program module, and is executed on a device on a target real or virtual processor to perform the processes or methods of the present disclosure. The program module includes routines, programs, libraries, objects, classes, components, data structures, and the like that execute particular tasks or implement particular abstract data types. Functions of the program module may be combined or divided between the program modules as desired in various example embodiments. A machine-executable instruction of the program module can be executed in a local or distributed device. In the distributed device, the program modules can be located on both local and remote storage media.

Program codes for executing the methods of the present disclosure may be written in any combination of one or more programming languages. These program codes are provided to a processor or controller of a general purpose computer, a dedicated computer, or other programmable data processing devices. When the program code is executed by the processor or controller, the functions/operations in the flowcharts and/or the implemented block diagrams are performed. The program code is executed entirely on a machine, partially on the machine as a stand-alone software package, partially on the machine and partially on a remote machine, or entirely on the remote machine or server.

The program can be stored and supplied to the computer using various types of non-transitory computer-readable media. The non-transitory computer-readable medium includes various types of tangible recording media. Examples of the non-transitory computer-readable medium include a magnetic recording medium, a magneto-optical recording medium, an optical disc medium, and a semiconductor memory. Examples of the magnetic recording medium include a flexible disk, a magnetic tape, and a hard disk drive. Examples of the magneto-optical recording medium include a magneto-optical disk. Examples of the optical disc medium include a Blu-ray disc, a compact disc (CD)-read only memory (ROM), a CD-recordable (R), and a CD-rewritable (RW). Examples of the semiconductor memory include a solid state drive, a mask ROM, a programmable ROM (PROM), an erasable PROM (EPROM), a flash ROM, and a random access memory (RAM). The program may be supplied to the computer using various types of transitory computer-readable media. Examples of the transitory computer-readable media include electrical signals, optical signals, and electromagnetic waves. The transitory computer-readable media can supply the programs to the computer via a wired communication path such as an electric wire and an optical fiber or a wireless communication path.

### Processing

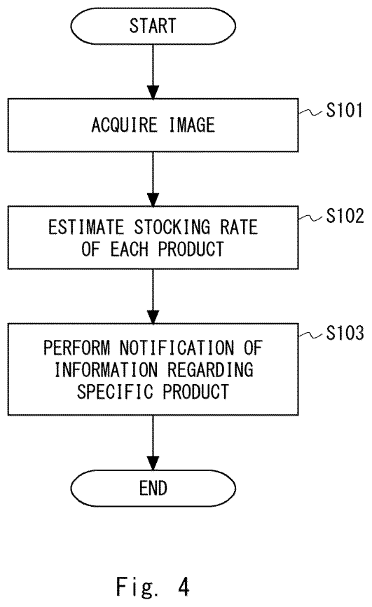

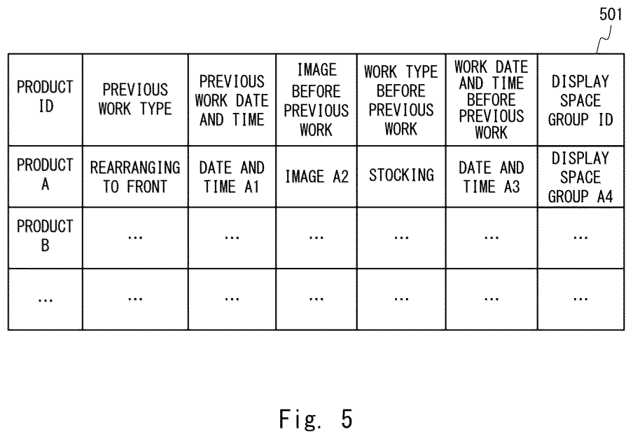

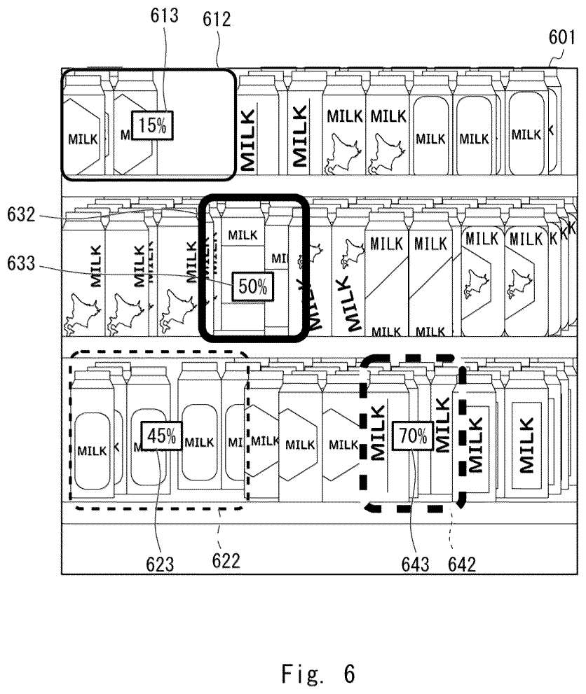

Next, an example of processing of the information processing device 10 according to the example embodiment will be described with reference to FIG. 4 to 6. FIG. 4 is a flowchart illustrating an example of the processing of the information processing device 10 according to the example embodiment. FIG. 5 is a diagram illustrating an example of a display work DB (database) 501 according to the example embodiment. FIG. 6 is a diagram illustrating an example of a display screen according to the example embodiment. The processing in FIG. 4 may be executed, for example, at a timing such as periodically (for example, every minute).

In step S101, the acquisition unit 11 acquires an image in which the display space of each product is photographed from the imaging device 20.

Subsequently, the estimation unit 12 estimates the stocking rate of each product in the display space based on the image acquired by the acquisition unit 11 (step S102). As a result, for example, it is possible to reduce time and effort for the salesclerk or the like to input the quantity or the like replenished from the backyard or the like to the store floor of the storefront for each product to the information processing device 10.

Here, the stocking rate of the product may be, for example, a ratio at which the product exists in the display space of the product captured by the imaging device 20. For example, in a case where a product shelf (a shelf on which products are displayed) having a plurality of stages is photographed from the imaging device 20 installed on a ceiling or the like of a store, a part of a display space of a certain product may become a blind spot due to another product or the like displayed on a stage above the stage on which the product is displayed. In this case, in a case where a product is appropriately (for example, in a state in which the alignment is performed such that there is no gap) displayed in a portion that is visible (not a blind) as viewed from the imaging device 20 in a display space of a certain product, the stocking rate of the product is 1 (100 %) regardless of whether the product exists in a portion that is a blind (invisible) as viewed from the imaging device 20.

For example, the estimation unit 12 may recognize the size of the display space of each product, the size of each product, and the number of each product using artificial intelligence (AI) or the like, and calculate each stocking rate. In this case, for example, in a case where twelve products can be displayed in a display space of a certain product viewed from the imaging device 20 and six products are displayed in the display space, the estimation unit 12 may calculate the stocking rate of the products to be 0.5 (= 6/12).

For example, the estimation unit 12 may calculate a value of a ratio between the number of pixels in which the product is captured in the region on the image relevant to the display space of the product captured by the imaging device 20 and the number of pixels of the region as the value of the stocking rate of the product. In this case, when the number of pixels in the region is 100 pixels and the number of pixels including the product in the region is 50 pixels, the stocking rate of the product is calculated to be 0.5 (= 50/100). The information indicating the region on the image relevant to the display space of the product captured by the imaging device 20 may be set (registered) in the information processing device 10 by the administrator or the like, for example, when the imaging device 20 is installed in a store or the like.

Subsequently, the control unit 13 refers to the display work DB 501, and performs notification of information regarding a specific product based on the stocking rate of the specific product estimated by the estimation unit 12 and whether a specific product has been stocked or has been rearranged to the front in the previous (latest, the past closest from the current time) work (step S103), and ends the processing.

In the example of FIG. 5, the previous work type, the previous work date and time, the image before the previous work, the work type before the previous work, the work date and time before the previous work, and the display space group ID are recorded in the display work DB 501 in association with the product ID. The product ID is identification information of each product. The product ID may be, for example, a product code such as a product name, a model number, or a Japanese Article Number (JAN) code. The work type is information indicating whether the product related to the product ID has been stocked or has been rearranged to the front in the work. The work type may include “stocking” and “rearranging to the front”.

The work date and time is a date and time when the salesclerk or the like performs the stocking or rearranging-to-the-front work. The image before the work is an image captured by the imaging device 20 at a point of time immediately before the salesclerk or the like performs the stocking or rearranging-to-the-front work. The display space group ID is, for example, information indicating a place where a product display space exists in a store. The display space group may be formed by, for example, one or more adjacent product shelves.

Stocking (replenishment) is, for example, work of displaying a product stored in a backyard of a store or the like in a display space of a store floor (storefront) of the store. At the time of stocking, for example, the salesclerk may display the product brought from the backyard of the store or the like on the back side of the display space after rearranging to the front. As a result, for example, old products can be displayed on the front side in order.

The rearranging-to-the-front is a work of taking out a product displayed on the back side of the display space to the front side after the product displayed on the front side of the display space is taken out by a customer. It should be noted that by performing the rearranging to the front, a customer can easily see and take the product.

The product ID may be set in advance by an administrator or the like of the information processing device 10. The previous work type and the work type before the previous work may be automatically determined and recorded by the information processing device 10, or may be recorded in response to an operation on the terminal 30 by a worker or the like.

### Determination of Work Type

Based on the image acquired by the acquisition unit 11, the control unit 13 may estimate whether each product has been stocked or has been rearranged to the front in each work by the salesclerk or the like. As a result, for example, it is possible to reduce time and effort for the salesclerk or the like to input the work type to the information processing device 10.

In this case, for example, when it is detected that the specific product is moved to the front side of the display space based on an image captured at a certain point of time, the control unit 13 may determine that the specific product has been stocked or rearrange to the front. Then, for example, the control unit 13 may estimate whether the specific product has been stocked or has been rearranged to the front based on a time length in which the salesclerk or the like has continuously stayed in front of the display space of the specific product as viewed from the imaging device 20 before the time point. In this case, for example, the control unit 13 may estimate that the rearranging-to-the-front is made in a case where the time length is less than the threshold, and may estimate that the stocking is made in a case where the time length is equal to or more than the threshold. This is because the time required for the work by the salesclerk or the like is longer in the case of stocking than in the case of rearranging to the front.

For example, when it is detected that the specific product is moved to the front side of the display space based on an image captured at a certain point of time, the control unit 13 may estimate that the specific product is rearranged to the front in a case where the stocking rate of the specific product is not 1 (100%).

### Notification

For example, in a case where the specific product has been rearranged to the front in the previous work, when the stocking rate of the specific product is equal to or less than the first threshold, the control unit 13 may perform notification of information prompting the stocking of the specific product. For example, in a case where the specific product has been stocked in the previous work, when the stocking rate of the specific product is equal to or less than a second threshold lower than the first threshold, the control unit 13 may perform notification of information prompting the stocking of the specific product. As a result, for example, in a case where it is considered that the number of products existing in the blind spot as viewed from the imaging device 20 is relatively smaller than the rearranging-to-the-front, it is possible to prompt the salesclerk or the like to stock the product more quickly. This is considered that a relatively large number of products exist in a blind spot as viewed from the imaging device 20 in a case where the products are stocked in the previous work. This is because it is considered that a relatively small number of products exist in a portion that is in a blind spot as viewed from the imaging device 20 in a case where the product is rearranged to the front in the previous work.

Furthermore, for example, in a case where the specific product has been stocked in the previous work, when the stocking rate of the specific product is equal to or less than a third threshold higher than the second threshold, the control unit 13 may perform notification of information prompting the rearranging of the specific product to the front. As a result, for example, in a case where it is considered that the number of products exist in the portion that is in the blind spot as viewed from the imaging device 20 is relatively larger than that in the previous stocking, it is possible to prompt the salesclerk or the like to perform the rearranging-to-the-front or the stocking of the product according to the number of products existing in the portion that is in the blind spot as viewed from the imaging device 20.

For example, in a case where the specific product has been rearranged to the front in the work before the previous work and the previous work, when the stocking rate of the specific product is equal to or less than a fourth threshold higher than the first threshold, the control unit 13 may perform notification of information prompting the stocking of the specific product. As a result, for example, in a case where it is considered that the number of products existing in the blind spot as viewed from the imaging device 20 is relatively smaller than the rearranging-to-the-front in the previous work and the rearranging-to-the-front before the previous work, it is possible to prompt the salesclerk or the like to stock the product more quickly.

### Example of Notification for Each Display Space Group

For each specific display space group, the control unit 13 may issue a notification for prompting the user to stock an article or the like. As a result, for example, the salesclerk or the like can collectively perform work on a plurality of products in a specific selling area corner, so that work efficiency can be improved.

In this case, the acquisition unit 11 may acquire an image in which the display space of each product is photographed. Then, the estimation unit 12 may estimate the stocking rate for the display space of each product based on the image. Then, in a case where the sum of the stocking rates is equal to or less than the specific threshold, and the stocking rate of a certain product is equal to or less than a threshold relevant to whether the product has been stocked or rearranged to the front in the previous work, the control unit 13 may perform notification of the information regarding the product. As a result, for example, when the stocking rate of the entire specific selling area corner is equal to or less than the threshold according to the selling area corner, it is possible to perform notification of each product according to the stocking rate of each product in the selling area corner.

In this case, the acquisition unit 11 may acquire an image in which the display space of the first product and the display space of the second product are photographed. Then, the estimation unit 12 may estimate a first stocking rate with respect to the display space of the first product and a second stocking rate with respect to the display space of the second product based on the image. Then, in a case where the sum of the first stocking rate and the second stocking rate is equal to or less than the specific threshold, and the first stocking rate is equal to or less than the threshold relevant to whether the first product has been stocked or rearranged to the front in the previous work, the control unit 13 may perform notification of the information regarding the first product.

### Example of Prompting for Stocking a Specific Product and Also Prompting for Stocking Other Products

The control unit 13 may also issue a notification for prompting the stocking of other products in addition to prompting the stocking of the specific product. As a result, for example, the salesclerk or the like can collectively perform work on a plurality of products in a specific selling area corner, so that work efficiency can be improved.

In this case, the acquisition unit 11 may acquire the image in which the display space of the first product and the display space of the second product are photographed. Then, the estimation unit 12 may estimate a first stocking rate with respect to the display space of the first product and a second stocking rate with respect to the display space of the second product based on the image.

Then, in a case where the first stocking rate is equal to or less than a threshold relevant to whether the first product has been stocked or rearranged to the front in the previous work, the control unit 13 may perform notification of the information regarding the first product. Then, in a case where the second stocking rate is equal to or less than a threshold relevant to whether the second product has been stocked or rearranged to the front in the previous work and the notification of the information regarding the first product, the control unit 13 may also perform notification of the information regarding the second product. As a result, for example, when prompting the stocking of the first product or the like, even when the stocking rate of the second product is relatively high, the stocking of the second product or the like can be also prompted to the salesclerk or the like.

### Display Example of Notification

The control unit 13 may display information indicating whether the specific product has been stocked or rearranged to the front in the previous work in association with a region in which the specific product is captured in the image acquired by the acquisition unit 11. As a result, for example, even when the back side of the display space is in a blind spot due to other products or the like and is difficult to see, the salesclerk or the like can easily estimate whether the products are displayed on the back side of the display space.

In the example of FIG. 6, the control unit 13 of the information processing device 10 displays, on a display screen 601 of the terminal 30, information (display object) indicating whether each product has been stocked or rearranged to the front in the previous work, information prompting the stocking of the product or the like, and information indicating the stocking rate of each product in a superimposed manner on the image. In the example of FIG. 6, the information indicating whether a certain product has been stocked or rearranged to the front in the previous work is displayed by the thickness of the line of the frame surrounding the region in which the product is captured. When the line is not a thick line (thin line), it indicates that the product has been stocked in the previous work. On the other hand, when the line is a thick line, it indicates that the product has been moved forward in the previous work.

In the example of FIG. 6, the information prompting the stocking of a certain product is displayed by a frame surrounding a region in which the product is captured. The control unit 13 displays the frame with a solid line in the case of prompting the stocking of the product, and displays the frame with a broken line in a case of prompting the rearranging of the product to the front. In the example of FIG. 6, the stocking rate of a certain product is displayed as a numerical value (%) in a region where the product is captured.

In the example of FIG. 6, information 612 indicating that the first product has been stocked in the previous work and prompting the first product to be stocked, and information 613 indicating the stocking rate of the first product are displayed in association with the region in which the first product is captured. The information 612 is displayed in a thin line to indicate that the first product has been stocked in the previous work, and is displayed in a solid line to prompt the stocking.

Information 622 indicating that the second product has been stocked in the previous work and prompting the user to rearrange the second product to the front and information 623 indicating the stocking rate of the second product are displayed in association with the region in which the second product is captured. The information 622 is displayed in a thin line to indicate that the second product has been stocked in the previous work and in a broken line to prompt the user to rearrange the second product to the front.

Information 632 indicating that a third product has been rearranged to the front in the previous work and prompting the stocking of the third product and information 633 indicating the stocking rate of the third product are displayed in association with the region in which the third product is captured. The information 632 is displayed in a thick line to indicate that the third product has been rearrange to the front in the previous work, and is displayed in a solid line to prompt the stocking.

Information 642 indicating that a fourth product has been rearranged to the front in the previous work and prompting the rearranging-to-the-front of the fourth product and information 643 indicating the stocking rate of the fourth product are displayed in association with the region in which the fourth product is captured. The information 642 is displayed with a thick line to indicate that the fourth product has been rearranged to the front in the previous work, and is displayed with a broken line to prompt the rearranging to the front.

In a case where a specific operation is performed on a region in which a specific product is captured in the image acquired by the acquisition unit 11, the control unit 13 may display an image in which a display space of the specific product is photographed at a time point before the previous work. In this case, for example, in a case where the information 612 of FIG. 6 is double-tapped (hit twice with a fingertip or the like) by the salesclerk or the like in the terminal 30, the control unit 13 may display an image in which the display space of the specific product is photographed at a time point before the previous work. The image in which the display space of the specific product is photographed at a time point before the previous work may be, for example, an image before the previous work recorded in the display work DB 501.

### Example of Notifying Notification Destination According to Previous Work Type

The control unit 13 may notify the notification destination according to the previous work type. In this case, in a case where the stocking rate of the specific product is equal to or less than a threshold according to whether the specific product has been stocked or has been rearranged to the front in the previous work, the control unit 13 may notify the notification destination according to whether the specific product has been stocked or has been rearranged to the front in the previous work, of the information regarding the specific product. As a result, for example, when the specific product is rearranged to the front in the previous work and the stocking rate of the specific product is relatively low, not only the salesclerk or the like but also the store manager or the like may be notified. As a result, for example, it is possible to further reduce the stock shortage (out of stock) of the specific product at the storefront.

### Modified Example

The information processing device 10 may be a device contained in one housing, but the information processing device 10 of the present disclosure is not limited thereto. Each unit of the information processing device 10 may be implemented by, for example, cloud computing including one or more computers. In addition, at least a part of the processing of the information processing device 10 may be realized by, for example, the terminal 30. The information processing device 10 may be, for example, a device (for example, it is housed in the same housing) integrated with at least one of the terminal 30 and the imaging device 20. Such an information processing device 10 is also included in an example of the “information processing device” of the present disclosure.

The present disclosure is not limited to the above-described example embodiments, and can be appropriately modified without departing from the scope.

Some or all of the above-described example embodiments may be described as the following supplementary notes, but are not limited to the following supplementary notes.

### Supplementary Note 1

An information processing device including:
an acquisition unit that acquires an image in which a display space of a product is photographed;
an estimation unit that estimates a stocking rate with respect to a display space of the product captured in the image based on the image; and
a control unit that performs notification of information regarding the product when the stocking rate is equal to or less than a threshold according to whether the product has been stocked or rearranged to a front in a previous work.

### Supplementary Note 2

The information processing device according to Supplementary Note 1,
in which the control unit is configured to:
perform notification of information prompting stocking of the product when the stocking rate is equal to or less than a first threshold in a case where the product has been rearranged to a front in the previous work; and
perform notification of information prompting stocking of a specific product when the stocking rate is equal to or less than a second threshold lower than the first threshold in a case where the product has been stocked in a previous work.

### Supplementary Note 3

The information processing device according to Supplementary Note 2, in which the control unit is configured to perform notification of information prompting rearranging of the product to a front when the stocking rate is equal to or less than a third threshold higher than the second threshold in a case where the product has been stocked in the previous work.

### Supplementary Note 4

The information processing device according to Supplementary Note 1, in which the control unit is configured to perform notification of information prompting stocking of the product when the stocking rate is equal to or less than a fourth threshold higher than the first threshold in a case where the product has been rearranged to a front before a previous work and in the previous work.

### Supplementary Note 5

The information processing device according to Supplementary Note 1, in which the control unit is configured to estimate whether the product has been stocked or rearranged to a front in previous work based on the image.

### Supplementary Note 6

The information processing device according to Supplementary Note 1, in which
the acquisition unit acquires the image in which a display space of a first product and a display space of a second product are photographed,
the estimation unit estimates a first stocking rate with respect to a display space of the first product and a second stocking rate with respect to a display space of the second product based on the image, and
the control unit performs notification of information regarding the first product when a sum of the first stocking rate and the second stocking rate is less than or equal to a specific threshold and the first stocking rate is less than or equal to a threshold according to whether the first product has been stocked or rearranged to a front in a previous work.

### Supplementary Note 7

The information processing device according to Supplementary Note 1, in which
the acquisition unit acquires the image in which a display space of a first product and a display space of a second product are photographed,
the estimation unit estimates a first stocking rate with respect to a display space of the first product and a second stocking rate with respect to a display space of the second product based on the image, and
the control unit performs notification of information regarding the first product and the second product when the first stocking rate is equal to or less than a threshold according to whether the first product has been stocked or rearranged to a front in a previous work and when the second stocking rate is equal to or less than a threshold according to whether the second product has been stocked or rearranged to a front in a previous work and notification of the information regarding the first product.

### Supplementary Note 8

The information processing device according to Supplementary Note 1, in which the control unit displays information indicating whether the product has been stocked or rearranged to a front in a previous work in association with a region in which the product is captured in the image.

### Supplementary Note 9

The information processing device according to Supplementary Note 8, in which the control unit displays an image in which a display space of the product is photographed at a time point before a previous work when a specific operation is performed on a region in which the product is photographed in the image.

### Supplementary Note 10

The information processing device according to Supplementary Note 1, in which the control unit notifies a notification destination of the information regarding the product according to whether the product has been stocked or rearranged to a front in a previous work when the stocking rate is equal to or less than a threshold according to whether the product has been stocked or rearranged to a front in a previous work.

### Supplementary Note 11

An information processing method including:
acquiring an image in which a display space of a product is photographed;
estimating a stocking rate with respect to a display space of the product captured in the image based on the image; and
performing notification of information regarding the product when the stocking rate is equal to or less than a threshold according to whether the product has been stocked or rearranged to a front in a previous work.

### Supplementary Note 12

A non-transitory computer-readable medium storing a program for causing a computer to execute:
acquiring an image in which a display space of a product is photographed;
estimating a stocking rate with respect to a display space of the product captured in the image based on the image; and
performing notification of information regarding the product when the stocking rate is equal to or less than a threshold according to whether the product has been stocked or rearranged to a front in a previous work.

### Supplementary Note 13

A management system including:
an imaging device; an information processing device; and a terminal,
in which the information processing device includes:
an acquisition unit that acquires an image in which a display space of a product is photographed by the imaging device;
an estimation unit that estimates a stocking rate with respect to a display space of the product captured in the image based on the image; and
a control unit that notifies the terminal of information regarding the product when the stocking rate is equal to or less than a threshold according to whether the product has been stocked or rearranged to a front in a previous work.

### REFERENCE SIGNS LIST

1 management system
10 information processing device
11 acquisition unit
12 estimation unit
13 control unit
20 imaging device
30 terminal

What is claimed is:

1. An information processing device comprising:
a memory storing instructions; and
a processor configured to execute the instructions to:
acquire an image in which a display space of a product is photographed;
estimate a stocking rate with respect to a display space of the product captured in the image based on the image; and
perform notification of information regarding the product when the stocking rate is equal to or less than a threshold according to whether the product has been stocked or rearranged to a front in a previous work.

2. The information processing device according to claim 1,
wherein the processor configured to execute the instructions to:
perform notification of information prompting stocking of the product when the stocking rate is equal to or less than a first threshold in a case where the product has been rearranged to a front in the previous work; and
perform notification of information prompting stocking of a specific product when the stocking rate is equal to or less than a second threshold lower than the first threshold in a case where the product has been stocked in a previous work.

3. The information processing device according to claim 2,
wherein the processor configured to execute the instructions to:
perform notification of information prompting rearranging of the product to a front when the stocking rate is equal to or less than a third threshold higher than the second threshold in a case where the product has been stocked in the previous work.

4. The information processing device according to claim 1,
wherein processor configured to execute the instructions to:
perform notification of information prompting stocking of the product when the stocking rate is equal to or less than a fourth threshold higher than the first threshold in a case where the product has been rearranged to a front before a previous work and in the previous work.

5. The information processing device according to claim 1,
wherein the processor configured to execute the instructions to:
estimate whether the product has been stocked or rearranged to a front in previous work based on the image.

6. The information processing device according to claim 1,
Wherein processor configured to execute the instructions to:
acquire the image in which a display space of a first product and a display space of a second product are photographed,
estimate a first stocking rate with respect to a display space of the first product and a second stocking rate with respect to a display space of the second product based on the image, and
perform notification of information regarding the first product when a sum of the first stocking rate and the second stocking rate is less than or equal to a specific threshold and the first stocking rate is less than or equal to a threshold according to whether the first product has been stocked or rearranged to a front in a previous work.

7. The information processing device according to claim 1,
Wherein processor configured to execute the instructions to:
acquire the image in which a display space of a first product and a display space of a second product are photographed,
estimate a first stocking rate with respect to a display space of the first product and a second stocking rate with respect to a display space of the second product based on the image, and
perform notification of information regarding the first product and the second product when the first stocking rate is equal to or less than a threshold according to whether the first product has been stocked or rearranged to a front in a previous work and when the second stocking rate is equal to or less than a threshold according to whether the second product has been stocked or rearranged to a front in a previous work and notification of the information regarding the first product.

8. The information processing device according to claim 1,
wherein processor configured to execute the instructions to:
display information indicating whether the product has been stocked or rearranged to a front in a previous work in association with a region in which the product is captured in the image.

9. The information processing device according to claim 8,
wherein the processor configured to execute the instructions to:
display an image in which a display space of the product is photographed at a time point before a previous work when a specific operation is performed on a region in which the product is photographed in the image.

10. The information processing device according to claim 1,
wherein the processor configured to execute the instructions to:
notify a notification destination of the information regarding the product according to whether the product has been stocked or rearranged to a front in a previous work when the stocking rate is equal to or less than a threshold according to whether the product has been stocked or rearranged to a front in a previous work.

11. An information processing method comprising:
acquiring an image in which a display space of a product is photographed;
estimating a stocking rate with respect to a display space of the product captured in the image based on the image; and
performing notification of information regarding the product when the stocking rate is equal to or less than a threshold according to whether the product has been stocked or rearranged to a front in a previous work.

12. A non-transitory computer-readable medium storing a program for causing a computer to execute:
acquiring an image in which a display space of a product is photographed;
estimating a stocking rate with respect to a display space of the product captured in the image based on the image; and
performing notification of information regarding the product when the stocking rate is equal to or less than a threshold according to whether the product has been stocked or rearranged to a front in a previous work.

13. (canceled)
